(19) United States
(12) Patent Application Publication
(10) Pub. No.: US 2026/0208339 A1
(43) Pub. Date: Jul. 23, 2026

(54) FASTENER DRIVING TOOL

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 19/434,227

(22) Filed: Dec. 29, 2025

(30) Foreign Application Priority Data
Jan. 20, 2025 (CN) 2025100879553

(51) Int. Cl. B25C 1/04; B25C 1/00

(52) U.S. Cl. CPC B25C 1/047; B25C 1/008; B25C 1/041

(57) ABSTRACT

A fastener driving tool, which relates to a power tool, includes a support cylinder, a striking unit having a driving piston and a striker, a driving gas chamber in fluid communication with a discharge volume, a lifting assembly configured to drive the striking unit to move in the first direction, and a gas supplementation unit disposed inside the support cylinder; the gas supplementation unit includes a gas supplementation piston and a gas supplementation chamber. When the striking unit moves in the second direction, the volume of the gas supplementation chamber decreases, allowing the gas in the gas supplementation chamber to enter the driving gas chamber. When the striking unit moves in the first direction, the volume of the gas supplementation chamber increases so that the ambient air may enter the gas supplementation chamber. The gas supplementation chamber realizes gas supplementation to the driving gas chamber, thereby ensuring the nailing effect.

### FIELD

The present disclosure relates to a power tool, and more particularly relates to fastener driving tool.

### BACKGROUND

A nail gun is a handheld nail driving tool that leverages a quickly-moving striker to drive a nail into a workpiece such as wood. Traditional pneumatic nail guns generally adopt a dual-cylinder dual-piston structure, where after the large piston in the larger cylinder moves to compress the gas in the larger cylinder to a predetermined level, the small piston in the smaller cylinder is released, so that the compressed gas in the larger cylinder flows through a gas passage into the smaller cylinder, driving the small piston in the smaller cylinder to move at a high velocity, and the moving small piston then actuates the striker to move synchronously to drive a nail into the workpiece such as wood, thereby completing a nailing action. The traditional pneumatic nail guns generally adopt a crank train to drive the large piston to move reciprocally. Since the crank train produces a large load-bearing deflection angle during its reciprocating motion, conditions such as thrust instability and excessive eccentric load easily occur when the crank train actuates the large piston to compress the gas, which in turn may jam the large piston during the gas-compressing process of the large piston.

To address the conditions noted supra, some pneumatic guns (e.g., U.S. Pat. No. 11,034,007B2 and its earlier patents) use a single-piston single-chamber structure instead, where high-pressure gas is filled in the gas storage chamber, and the upward moving piston compresses the gas in the gas storage chamber, so that the high-pressure gas compressed in the gas storage chamber may act as a gas spring to actuate the piston to drive the striker to move quickly to drive a nail into a workpiece. Since gas leakage tends to occur in the gas storage chamber, the gas pressure of the compressed gas in the gas storage chamber will drop after the pneumatic gun is used for a period of time; consequently, the driving effect of the compressed gas on the piston and the striker also degrades, leading to unsatisfactory nailing performance and thereby impairing user experience.

### SUMMARY

To overcome the above and other drawings in conventional technologies, the present disclosure provides a fastener driving tool, which realizes gas supplementation to a driving gas chamber via a gas supplementation unit additionally provided herein, thereby ensuring a nailing effect.

A fastener driving tool provided herein comprises:
a support cylinder, two axial ends of which are oriented in a first direction and a second direction, respectively;
a striking unit having a driving piston and a striker, the driving piston being disposed inside the support cylinder in an axially movable manner, the support cylinder having a displacement volume created by a stroke of the driving piston, one end of the striker facing the first direction being connected to the driving piston, and one end of the striker facing the second direction being configurable to engage a to-be-driven fastener;
a driving gas chamber in fluid communication with the displacement volume, high-pressure gas in the driving gas chamber being capable of driving the striking unit to move in the second direction; and
a lifting assembly configured to drive the striking unit to move in the first direction;
wherein the fastener driving tool further comprises a gas supplementation unit disposed inside the support cylinder, the gas supplementation unit comprising a gas supplementation piston and a gas supplementation chamber, the gas supplementation piston being connected to the striker and disposed in the second direction of the driving piston, the gas supplementation chamber being disposed between the driving piston and the gas supplementation piston, the gas supplementation piston being movable within a predetermined range relative to the striker to induce variation of a volume of the gas supplementation chamber;
while the striking unit is moving in the second direction, the volume of the gas supplementation chamber is reduced, allowing gas in the gas supplementation chamber to enter the driving gas chamber; and
while the striking unit is moving in the first direction, the volume of the gas supplementation chamber expands, allowing ambient air to enter the gas supplementation chamber.

In some embodiments, the driving piston is provided thereon with a gas supplementation hole and a gas supplementation check valve configured to open/close the gas supplementation hole, the gas supplementation check valve being adapted to open the gas supplementation hole when gas pressure in the gas supplementation chamber is higher than gas pressure in the driving gas chamber.

In some embodiments, the gas supplementation piston is provided thereon with a gas inlet hole and a gas inlet check valve configured to open/close the gas inlet hole, the gas inlet check valve being adapted to open the gas inlet hole when atmospheric pressure of ambient air is higher than gas pressure in the gas supplementation chamber.

In some embodiments, the fastener driving tool further comprises a pressure relief valve configured to adjust gas pressure in the driving gas chamber, the pressure relief valve being adapted to open when the gas pressure in the driving gas chamber exceeds a predetermined pressure relief value.

In some embodiments, a damper block that is elastic is provided at the end of the support cylinder facing the second direction, and the striking unit continues moving in the second direction after the gas supplementation piston engages the damper block, thereby compressing the volume of the gas supplementation chamber.

In some embodiments, the striking unit moves in the first direction prior to the gas supplementation piston, and the volume of the gas supplementation chamber expands as the striking unit moves in the first direction prior to the gas supplementation piston.

In some embodiments, the gas supplementation piston is sleeved on the striker, the striker being provided with a limiting portion configured to limit the gas supplementation piston, the gas supplementation piston being movable between the driving piston and the limiting portion relative to the striker.

In some embodiments, the striker moving in the first direction may drive, via the limiting portion, the gas supplementation piston to move synchronously; and/or, the striker is provided with a support portion between the driving piston and the limiting portion, the support portion having an outer diameter smaller than that of the limiting portion, the gas supplementation piston being disposed at the support portion, a sealing ring being provided between the support portion and the gas supplementation piston to maintain a circumferential sealing fit therebetween.

In some embodiments, the driving piston and the support cylinder maintain a circumferential sealing fit; and/or, the gas supplementation piston and the support cylinder maintain a circumferential sealing fit.

In some embodiments, the driving gas chamber is arranged to surround at least part of the support cylinder, and the driving gas chamber is at least partially disposed above the support cylinder.

With the technical solution noted supra, the present disclosure offers the following benefits:
1. The fastener driving tool described herein offers an improved structure, which additionally provides a gas supplementation unit comprising a gas supplementation piston and a gas supplementation chamber, the gas supplementation piston being connected to the striker, the gas supplementation chamber being disposed between the driving piston and the gas supplementation piston; since the gas supplementation piston is movable within a certain range relative to the striker, the volume of the gas supplementation chamber may be varied with movement of the gas supplementation piston. When the striking unit moves in the second direction to drive a nail, the volume of the gas supplementation chamber is reduced; correspondingly, the gas pressure in the gas supplementation chamber is increased. As the volume of the driving gas chamber gradually expands when the striking unit moves in the second direction, the gas pressure in the driving chamber is gradually decreased; when the gas pressure in the gas supplementation chamber is greater than that in the driving gas chamber, the gas in the gas supplementation chamber may enter the driving gas chamber under the pressure difference. When the striking unit moves in the first direction to accumulate energy, the volume of the driving chamber is decreased gradually, resulting in gradual increase of the gas pressure in the driving gas chamber; in addition, the volume of the gas supplementation chamber is increased and correspondingly the gas pressure in the gas supplementation chamber is decreased; when the atmospheric pressure of the ambient air is greater than the gas pressure in the gas supplementation chamber, the ambient air enters the gas supplementation chamber under the pressure difference; the air entering the gas supplementation chamber may be forced into the driving gas chamber when the striking unit performs the next driving action. This additionally provided gas supplementation unit performs gas supplementation to the driving gas chamber, which ensures the pressure intensity of the compressed gas in the driving gas chamber and in turn guarantees the driving force exerted by the compressed gas in the driving gas chamber against the striking unit when performing a nailing action, thereby ensuring the nailing effect and enhancing user experience.

Additionally, with the gas supplementation unit that inflates the driving gas chamber, the driving gas chamber may not be pre-charged or may be only partially pre-charged with high-pressure gas at the factory, so that prior to performing a nailing action, the driving gas chamber is first inflated with the gas supplementation unit, and after the gas pressure in the driving gas chamber satisfies the nailing requirement, the tool starts the nailing action; this may reduce or eliminate a potential explosion risk of the tool incurred by the pre-charged high-pressure gas in the driving gas chamber. In addition, since the driving gas chamber is not pre-charged or is only partially pre-charged with high-pressure gas at the factory, other relevant components of the tool are in an unloaded or lightly loaded state, which helps to guarantee performance and service life of the other relevant components.
2. A gas supplementation hole and a gas supplementation check valve are provided on the driving piston; the gas supplementation check valve normally closes the gas supplementation hole; when the striking unit moves in the second direction so that the gas pressure in the gas supplementation chamber is higher than that in the driving gas chamber, the gas supplementation check valve opens the gas supplementation hole under the gas pressure, allowing the gas in the gas supplementation chamber to enter the driving gas chamber via the gas supplementation hole. This reasonable structural configuration of the driving piston facilitates the gas in the gas supplementation chamber to enter the driving gas chamber under pressure difference, thereby realizing gas supplementation to the driving gas chamber.
3. A gas inlet hole and a gas inlet check valve are provided on the gas supplementation chamber; the gas inlet check valve normally closes the gas inlet hole; when the striking unit moves in the first direction so that the atmospheric pressure of the ambient air is higher than the gas pressure in the gas supplementation chamber, the gas inlet check valve opens the gas inlet hole under pressure difference, allowing the ambient air to enter the gas supplementation chamber via the gas inlet hole. This reasonable structural configuration of the gas supplementation piston facilitates the ambient air to enter the gas supplementation chamber under the pressure difference and is temporarily stored therein, which may enter the driving gas chamber subsequently.
4. The tool is provided with a pressure relief valve configured to adjust the gas pressure in the driving gas chamber; the pressure relief valve is in a normally closed state; when the gas pressure in the driving gas chamber exceeds a predetermined pressure relief value, the pressure relief valve is opened, allowing the gas in the driving gas chamber to be discharged out of the driving gas chamber via the pressure relief valve, thereby preventing cylinder blowout due to excessive gas pressure in the driving gas chamber, which ensures the nailing effect while guaranteeing operational safety of the tool.
5. A damper block is provided at one end of the support cylinder; when the striking unit moves in the second direction till the gas supplementation piston hits the damper block and stops moving, the striking unit continues moving in the second direction, i.e., the driving piston continues moving closer to the gas supplementation piston after the gas supplementation piston stops; now, the gas supplementation chamber between the driving piston and the gas supplementation piston is abruptly compressed, and correspondingly the gas pressure in the gas supplementation chamber is also abruptly increased till being higher than that in the driving gas chamber, allowing the gas in the gas supplementation chamber to enter the driving gas chamber due to the abrupt pressure rise. In addition, volume reduction of the gas supplementation chamber may provide a certain role of damping to the striker, which may significantly reduce vibration of the tool upon nailing, helping to improve user experience.
6. As the striking unit moves in the first direction, the striking unit moves prior to the gas supplementation piston. If the driving piston moves first, the volume of the gas supplementation chamber is increased, and correspondingly, the gas pressure in the gas supplementation chamber is decreased till being lower than or equal to the atmospheric pressure, allowing the ambient air to enter the gas supplementation chamber under pressure difference.
7. The striker is provided with a limiting portion; the gas supplementation piston is sleeved on the striker and movable between the driving piston and the limiting portion relative to the striker; the axial position of the gas supplementation piston is limited by the driving piston and the limiting portion so that the gas supplementation piston moves within a certain range relative to the striker, and the striker moving in the first direction may drive the gas supplementation piston together via the limiting portion.

The gas supplementation piston is disposed at a support portion of the striker; the support portion and the gas supplementation piston maintain a circumferential sealing fit via a sealing ring, which prevents the gas in the gas supplementation chamber from leaking out via the assembly interstice between the support portion and the gas supplementation piston when the volume of the gas supplementation chamber is decreased, thereby ensuring the gas supplementation chamber's performance in supplementing gas to the driving gas chamber.

### BRIEF DESCRIPTION OF THE DRAWINGS

FIG. 1 is an overall view of a fastener driving tool in a first embodiment;

FIG. 2 is a schematic diagram when the fastener is not driven into a workpiece yet in the first embodiment;

FIG. 3 is a schematic diagram after the fastener is driven into the workpiece in the first embodiment;

FIG. 4 is a partial structural view of the fastener driving tool in the first embodiment;

FIG. 5 is an axial sectional view of a striking unit, a gas supplementation unit, and a cylinder unit in the first embodiment;

FIG. 6 is a magnified view of part A in FIG. 5;

FIG. 7 is a partial structural view of a striker in the first embodiment;

FIG. 8 is a structural view of a driving piston in the first embodiment;

FIG. 9 is a structural view of a gas supplementation piston in the first embodiment;

FIGS. 10a, 10b, 10c, 10d, 10e are schematic diagrams of a part of structure in different states during a nailing cycle;

FIG. 11 is an exploded view of a part of structure in the first embodiment;

FIG. 12 is a sectional view of a support base, a guide base, and a striker in a anteroposterior direction in the first embodiment;

FIG. 13 is a schematic diagram of fitting between a lifting gear and the striker the first embodiment;

FIG. 14 is an exploded view of a lifting assembly in the first embodiment;

FIG. 15 is a structural view of fitting between a part of structure of the lifting assembly and a latch block in the first embodiment;

FIG. 16 is an axial sectional view of a part of structure of the lifting assembly in the first embodiment;

FIG. 17 is a structural view of fitting between a driving wheel and a driven wheel in the first embodiment;

FIG. 18 is a structural view of the driving wheel in the first embodiment;

FIG. 19 is a structural view of fitting between a cam and the latch block in the first embodiment;

FIG. 20 is a structural view of fitting between the latch block and a limit switch in the first embodiment;

FIG. 21 is an exploded view of a safety assembly and the guide base in the first embodiment;

FIG. 22 is an axial section view of a part of structure when the cylinder unit adopts an irregular structure in the first embodiment.

In the drawings: 10—fastener driving tool;
2A—striking unit; 21—driving piston; 211—connecting hole; 212—gas supplementation hole; 213—gas supplementation check valve; 214—first mounting hole; 215—first stepped surface; 216—sealing ring IV; 217—first limit plate; 22—striker; 221—connecting portion; 222—support portion; 223—limiting portion; 23—support cylinder; 23A—displacement volume; 24—driving gas chamber; 2B—gas supplementation unit; 25—gas supplementation piston; 251—sleeved hole; 252—gas inlet hole; 253—gas inlet check valve; 254—second mounting hole; 255—second stepped surface; 256—sealing ring V; 257—second limit plate; 26—gas supplementation chamber; 27—cylinder unit; 271—cylinder housing; 272—cylinder head; 273—base; 274—pressure relief valve; 2741—valve housing; 2742—valve cover; 2743—valve stem; 2744—spring; 2745—cavity; 2746—exhaust hole; 275—pressure relief hole; 276—gas charging valve; 28—damper block; 281—through hole; 291—sealing ring I; 292—sealing ring II;
31—fastener; 32—workpiece;
40—lifting assembly; 41—lifting gear; 42—transmission shaft; 43—electric motor; 44—reduction gearbox; 441—output shaft; 451—driving wheel; 4511—recessed cavity; 452—driven wheel; 461—drive ratchet groove; 462—drive ratchet; 463—first spring;
50—enclosure; 51—body portion; 52—accommodation portion; 53—grip portion; 54—receiving portion; 55—reinforcement portion;
61—support base; 62—rod shaft; 63—guide base; 64—limit passage; 65—guide passage; 66—trigger;
71—latch block; 72—second spring; 73—cam; 74—limit switch; 75—pin rod;
80—nail feeder; 81—guide cover;
90—safety assembly; 91—driver rod; 92—safety switch; 93—third spring; 94—contact plate; 95—locating rack; 96—elastic member.

### DETAILED DESCRIPTION OF EMBODIMENTS

Hereinafter, the present disclosure will be further described through specific embodiments referring to the drawings. It is appreciated that the orientational or positional relationships indicated by the terms “upper,” “lower,” “left,” “right,” “longitudinal,” “transverse,” “inner,” “outer,” “vertical,” “horizontal,” “top,” and “bottom” are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to this disclosure.

### First Embodiment

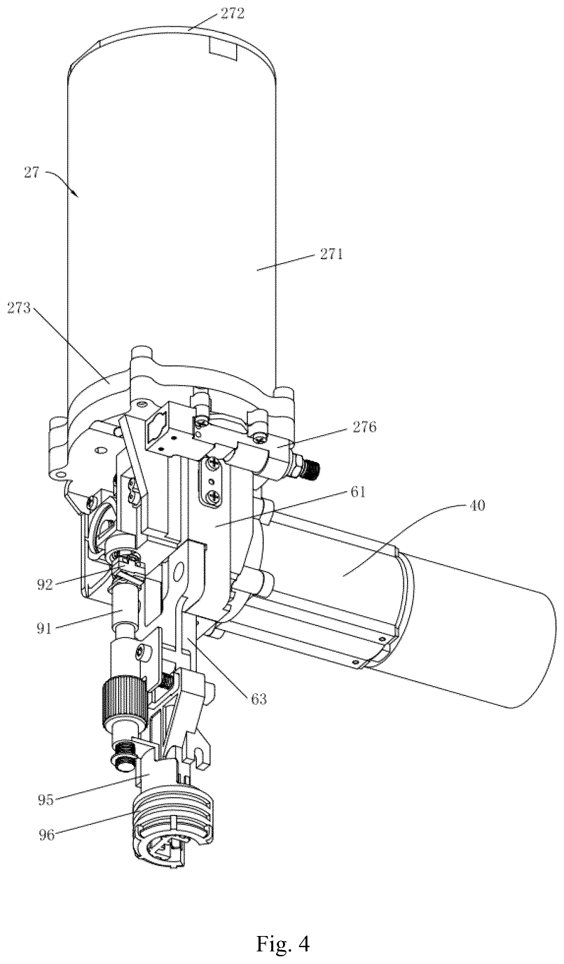

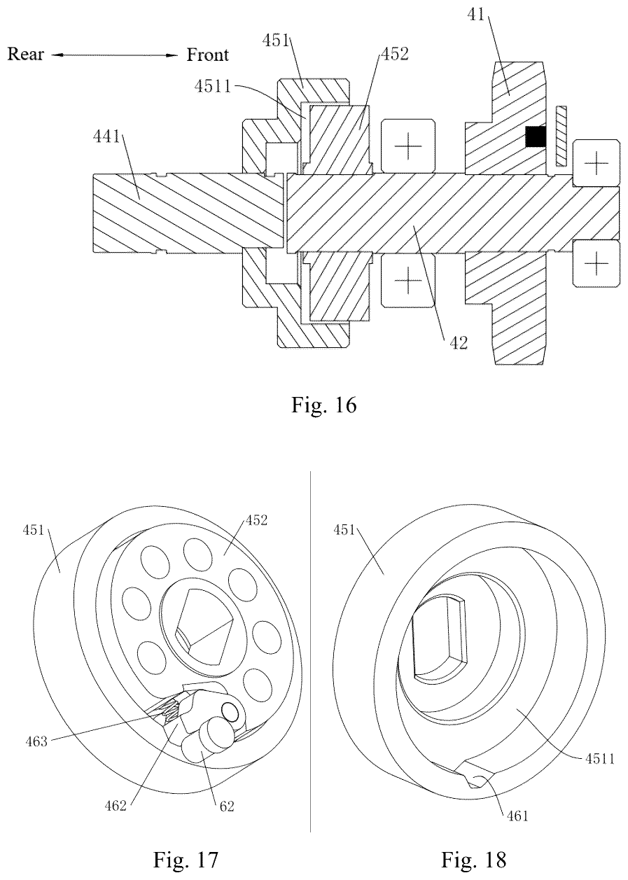

Referring to FIGS. 1-21, a fastener driving tool 10 provided according to the fir implementation of the present disclosure comprises:
a support cylinder 23, two axial ends of which are oriented in a first direction and a second direction, respectively;
a striking unit 2A having a driving piston 21 and a striker 22, the driving piston 21 being axially movably disposed inside the support cylinder 23, the support cylinder 23 having a displacement volume 23A created by a stroke of the driving piston 21, one end of the striker 22 facing the first direction being connected to the driving piston 21, one end thereof facing the second direction being configurable to engage a to-be-driven fastener 31;
a driving gas chamber 24 in fluid communication with the displacement volume 23A, a high-pressure gas in the driving gas chamber 24 being configurable to drive the striking unit 2A to move in the second direction;
a lifting assembly 40 configured to drive the the striking unit 2A to move in the first direction;
a gas supplementation unit 2B disposed in the support cylinder 23, the gas supplementation unit 2B comprising a gas supplementation piston 25 and a gas supplementation chamber 26, the gas supplementation piston 25 being connected to the striker 22 and oriented in the second direction of the driving piston 21, the gas supplementation chamber 26 being disposed between the driving piston 21 and the gas supplementation piston 25, the gas supplementation piston 25 being movable relative to the striker 22 within a certain extent so as to vary a volume of the gas supplementation chamber 26;
as the striking unit 2A moves in the second direction, the volume of the gas supplementation chamber 26 is reduced, allowing the gas in the gas supplementation chamber 26 to enter the driving gas chamber 24;
and as the striking unit 2A moves in the first direction, the volume of the gas supplementation chamber 26 expands, allowing external air to enter the gas supplementation chamber 26.

The gas supplementation unit 2B additionally provided herein allows gas supplementation to the driving gas chamber 24, which ensures pressure intensity of the compressed gas in the driving gas chamber 24 and in turn ensures driving force of the compressed gas in the driving gas chamber 24 against the striking unit 2A, thereby ensuring nailing effect and enhancing user experience. In addition, with the gas supplementation unit 2B to supplement gas to the driving gas chamber, it eliminates a need to pre-charge a high-pressure gas into the driving gas chamber 24 when the tool is at the factory; or, it is only needed to partially pre-charge the high-pressure gas while supplementing the gas to the driving gas chamber 24 using the gas supplementation unit 2B before a nailing action, and then the nailing action is performed when the gas pressure in the driving gas chamber 24 reaches a nailing requirement; this may lower or eliminate a risk of explosion to the tool caused otherwise by the pre-charged high-pressure gas in the driving gas chamber 24. Furthermore, as no high-pressure gas is pre-charged in the driving gas chamber 24 or the high-pressure gas is only partially pre-charged when the tool is at the factory, relevant components of the tool are in an unloaded or only lightly loaded state, which ensures performance and service life of these components.

In this embodiment, the support cylinder 23 is arranged with its axis substantially vertical, one end of which faces upward while an opposite end thereof faces downward. Referring to FIG. 1, the fastener driving tool 10 further comprises an enclosure 50. The enclosure 50 exemplarily adopts a laterally oppositely openable housing structure, and is formed with a body portion 51 extending substantially in a vertical direction, an accommodation portion 52 extending rearward from a lower part of the body portion 51 and being configurable to accommodate a part of components of the lifting assembly 40, and a grip portion 53 extending rearward from an upper part of the body portion 51 and being adapted for a user to grip, a certain gap extending vertically being present between the grip portion 53 and the accommodation portion 52. The fastener driving tool 10 according to this embodiment is exemplarily powered by a battery pack that is exemplarily mounted in a detachable manner, a receiving portion 54 in which the battery pack is mounted being formed at a rear end of the grip portion 53.

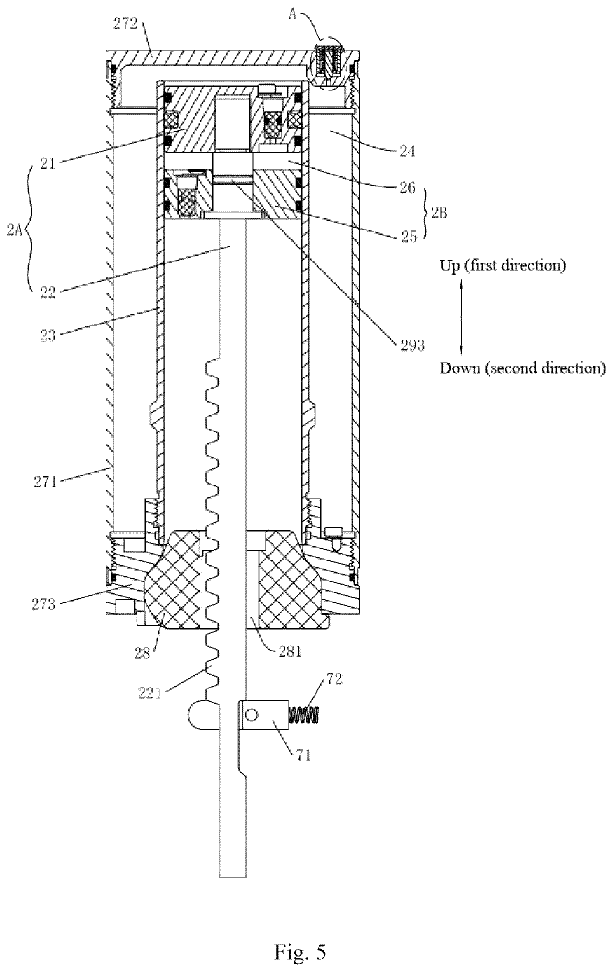

Referring to FIG. 5, in this embodiment, the fastener driving tool 10 further comprises a cylinder unit 27. Specifically, the cylinder unit 27 comprises a cylinder housing 271, a cylinder head 272, and a base 273; the base 273 is secured in the body portion 51; the support cylinder 23 has a hollow cylindrical shape with its upper and lower ends open, a lower end thereof being secured on the base 273 and maintaining a circumferential sealing fit with the base 273; and the cylinder housing 271 also has a hollow cylindrical shape with its upper and lower ends open, the cylinder housing 271 being sleeved on an outer circumference of the support cylinder 23 with a gap therebetween; the lower end of the cylinder housing 271 is secured on the base 273 and maintains a circumferential sealing fit with the base 273; the cylinder head 272 is secured to the upper end of the cylinder housing 271 and maintains a circumferential sealing fit with the cylinder housing 271; a top surface of the support cylinder 23 is lower than an underside of the cylinder head 272 so that a certain axial gap is present between the upper end of the support cylinder 23 and the cylinder head 272, allowing the driving gas chamber 24 to be partially located above the support cylinder 23. A damper block 28 disposed on an inner circumference of the base 273 is provided at the lower end of the support cylinder 23 the damper block 28 is made of an elastic material such as rubber, which can limit an extreme position of the striking unit 2A moving in the second direction, a through hole 281 for the striker 22 to pass through being formed in a center of the damper block 28. The driving piston 21 is disposed inside the support cylinder 23 in an up-down movable manner, a plurality of sealing rings I 291 spaced apart from each other being axially positioned and sleeved on an outer circumference of the driving piston 21, the sealing rings I 291 abutting against an inner surface of the support cylinder 23; with the sealing rings I 291, the driving piston 21 and the support cylinder 23 maintain a circumferential sealing fit. The driving gas chamber 24 is enclosed by the cylinder unit 27, the support cylinder 23, and the driving piston 21 volume of the driving gas chamber 24 varies with movement of the driving piston 21. As an exemplary solution of this embodiment, the support cylinder 23 and the cylinder housing 271 both have a hollow cylindrical shape, with their central axes being substantially coincident; the driving gas chamber 24 is arranged around an entirety of the support cylinder 23. In an alternative solution of this embodiment, the cylinder housing 271 can also be configured with another appropriate shape such as a hollow square cylindrical shape or an elliptical cylindrical shape. Additionally, the central axes of the support cylinder 23 and the cylinder housing 271 can also be offset by a certain distance, i.e., their central axes may not be coincident. Furthermore, an axial length of the cylinder housing 271 may also be smaller than that of the support cylinder 23, in which case the driving gas chamber 24 is arranged around a part of the support cylinder 23. It is appreciated that the cylinder housing 271 and the cylinder head 272 of the cylinder unit 27 can also be unitarily formed. Of course, a specific structure of the cylinder unit 27 is not limited to the foregoing description and the illustrated drawings, where the cylinder unit 27 may also adopt another cylindrical structure that can form the driving gas chamber 24.

The upper portion of the striker 22 passes through the through hole 281 in the damper block 28 into the support cylinder 23 to connect to the driving piston 21. Specifically, the driving piston 21 is provided with a connecting hole 211, an upper end of the connecting hole 211 being closed, a lower end of the connecting hole 211 being open. Referring to FIG. 7, an upper end of the striker 22 is provided with a connecting portion 221 fitted with the connecting hole 211, the connecting portion 221 being inserted into the connecting hole 211. The upper end of the striker 22 may be connected to the driving piston 21 via thread fit or pin fit so that the driving piston 21 and the striker 22 constituting the striking unit 2A may move synchronously.

Referring to FIG. 7, in this embodiment, the upper end of the striker 22 is further provided with a support portion 222 and a limiting portion 223. The connecting portion 221, the support portion 222, and the limiting portion 223 are sequentially distributed from top to bottom, with their outer diameters sequentially increasing. The gas supplementation piston 25 is provided with a sleeved hole 251 that is in clearance fit with the support portion 222, the gas supplementation piston 25 being sleeved on the upper portion of the striker 22 via fit between the sleeved hole 251 and the support portion 222, the gas supplementation piston 25 being disposed below the driving piston 21. Furthermore, axial height H1 of the support portion 222 is greater than axial height H2 of the gas supplementation piston 25, the gas supplementation piston 25 being movable up and down relative to the support portion 222. An outer diameter of the limiting portion 223 is greater than an inner diameter of the sleeved hole 251, and a stroke of the gas supplementation piston 25 moving up and down relative to the support portion 222 is limited by the driving piston 21 and the limiting portion 223, so that the gas supplementation piston 25 can move up and down relative to the striker 22 within a certain height range.

The gas supplementation chamber 26 is enclosed by the driving piston 21, the gas supplementation piston 25, and the support cylinder 23. To ensure sealing performance of the gas supplementation chamber 26, in this embodiment, a plurality of sealing rings II 292 spaced apart from each other are axially positioned and sleeved on an outer circumference of the gas supplementation piston 25, the sealing rings II 292 abutting against an inner surface of the support cylinder 23, so that the gas supplementation piston 25 and the support cylinder 23 maintain a circumferential sealing fit via the sealing rings II 292. In addition, a sealing ring III 293 is axially positioned and sleeved on an outer circumference of the support portion 222, the sealing ring III 293 abutting against an inner wall of the sleeved hole 251, so that the gas supplementation piston 25 and the support portion 222 maintain a circumferential sealing fit via the sealing ring III 293.

Referring to FIG. 8, the driving piston 21 is provided thereon with a gas supplementation hole 212 and a gas supplementation check valve 213 configured to open and close the gas supplementation hole 212, where the gas supplementation check valve 213 opens the gas supplementation hole 212 when gas pressure in the gas supplementation chamber 26 is higher than that in the driving gas chamber 24, allowing the gas in the gas supplementation chamber 26 to smoothly enter the driving gas chamber 24. Specifically, the driving piston 21 is provided thereon with a first mounting hole 214 having an outer diameter gradually decreasing from top to bottom, the first mounting hole 214 extending downward to a certain depth from an upper surface of the driving piston 21, the gas supplementation hole 212 extending upward to a certain depth from a lower surface of the driving piston 21, the gas supplementation hole 212 and the first mounting hole 214 communicating with each other, an aperture of the first mounting hole 214 being greater than that of the gas supplementation hole 212 so that a first stepped surface 215 is formed therebetween. The gas supplementation check valve 213 has a substantially columnar shape with its outer size gradually decreasing from top to bottom and is disposed in the first mounting hole 214 in an up-down movable manner, an outer size of the gas supplementation check valve 213 being slightly smaller than that of the first mounting hole 214 but greater than that of the gas supplementation hole 212, an axial height of the gas supplementation check valve 213 being smaller than a depth of the first mounting hole 214, a sealing ring IV 216 being axially positioned and sleeved on an outer circumference of the gas supplementation check valve 213. When the gas pressure in the gas supplementation chamber 26 is lower than or equal to that in the driving gas chamber 24, the gas supplementation check valve 213 abuts against the first stepped surface 215 under the action of the gas pressure in the driving gas chamber 24, where an underside of the gas supplementation check valve 213 abuts against the first stepped surface 215 to close the gas supplementation hole 212, and the sealing ring IV 216 abuts against an inner wall of the first mounting hole 214 to maintain the gas supplementation check valve 213 and the driving piston 21 in a circumferentially sealed state. When the gas pressure in the gas supplementation chamber 26 is higher than that in the driving gas chamber 24, the gas supplementation check valve 213 moves upward relative to the driving piston 21 under the action of the pressure difference, so that the underside of the gas supplementation check valve 213 migrates from the first stepped surface 215 to open the gas supplementation hole 212, and at the same time, the sealing ring IV 216 moving upward with the gas supplementation check valve 213 is also separated from the inner wall of the first mounting hole 214, i.e., a certain circumferential gap is present between the gas supplementation check valve 213 and the inner wall of the first mounting hole 214, allowing the gas in the gas supplementation chamber 26 to enter the driving gas chamber 24 via the opened gas supplementation hole 212 and the circumferential gap, thereby realizing gas supplementation to the driving gas chamber 24. In addition, to prevent the upwardly moving gas supplementation check valve 213 from migrating out of the first mounting hole 214, a first limit plate 217 configured to limit the gas supplementation check valve 213 is provided for the driving piston 21 on top of the first mounting hole 214, where the gas supplementation check valve 213, moving upward relative to the driving piston 21 travels at most up to the first limit plate 217. Of course, the gas supplementation check valve 213 can also adopt another existing check valve structure that meets gas supplement requirements, and a specific structure of the gas supplementation check valve 213 is not limited in this embodiment.

Referring to FIG. 9, the gas supplementation piston 25 is provided thereon with a gas inlet hole 252 and a gas inlet check valve 253 configured to open and close the gas inlet hole 252 the gas inlet check valve 253 opening the gas inlet hole 252 when an atmospheric pressure of ambient air is higher than a gas pressure in the gas supplementation chamber 26, allowing the ambient air to smoothly enter the gas supplementation chamber 26. Specifically, the gas supplementation piston 25 is provided thereon with a second mounting hole 254 having an outer diameter gradually decreasing from top to bottom, the second mounting hole 254 extending downward by a certain depth from the upper surface of the gas supplementation piston 25, the gas inlet hole 252 extending upward by a certain depth from the lower surface of the gas supplementation piston 25, the gas inlet hole 252 and the second mounting hole 254 communicating with each other, an aperture of the second mounting hole 254 being greater than that of the gas inlet hole 252 with a second stepped surface 255 formed therebetween. The gas inlet check valve 253 has a substantially columnar shape with its outer size decreasing from top to bottom, the gas inlet check valve 253 being disposed in the second mounting hole 254 in an up-down movable manner, the outer size of the gas inlet check valve 253 being slightly smaller than the aperture of the second mounting hole 254 but greater than the aperture of the gas inlet hole 252, an axial height of the gas inlet check valve 253 being smaller than the depth of the second mounting hole 254, a sealing ring V 256 being axially positioned and sleeved on an outer circumference of the gas inlet check valve 253. When the gas pressure in the gas supplementation chamber 26 is higher than or equal to the atmospheric pressure of the ambient air, the gas inlet check valve 253 abuts against the second stepped surface 255 under the action of the gas pressure in the gas supplementation chamber 26, where an underside of the gas inlet check valve 253 abuts against the second stepped surface 255 to close the gas inlet hole 252, and the gas inlet hole 252 abuts against an inner wall of the second mounting hole 254 so that the gas inlet check valve 253 and the gas supplementation piston 25 are disposed in a circumferentially sealed state. When the atmospheric pressure of the ambient air is higher than the gas pressure in the gas supplementation chamber 26, the gas inlet check valve 253 moves upward relative to the gas supplementation piston 25 under pressure difference, so that the underside of the gas inlet check valve 253 migrates upward from the second stepped surface 255 to open the gas inlet hole 252; meanwhile, the sealing ring V 256 moves upward with the gas inlet check valve 253 to detach from the inner wall of the second mounting hole 254, that is, a certain circumferential gap is present between the gas inlet check valve 253 and the inner wall of the second mounting hole 254, allowing ambient air to enter the gas supplementation chamber 26 via the opened gas inlet hole 252 and the circumferential gap, thereby realizing air inlet into the gas supplementation chamber 26. In addition, to prevent the upwardly moving gas inlet check valve 253 from migrating out of the second mounting hole 254, a second limit plate 257 configured to limit the gas inlet check valve 253 is provided for the gas supplementation piston 25 and disposed on top of the second mounting hole 254 so that the gas inlet check valve 253, moving upward relative to the gas supplementation piston 25, moves up to the second limit plate 257. Of course, the gas inlet check valve 253 can also adopt another existing check valve structure that meets air inlet requirements, and a specific structure of the gas inlet check valve 253 is not limited herein.

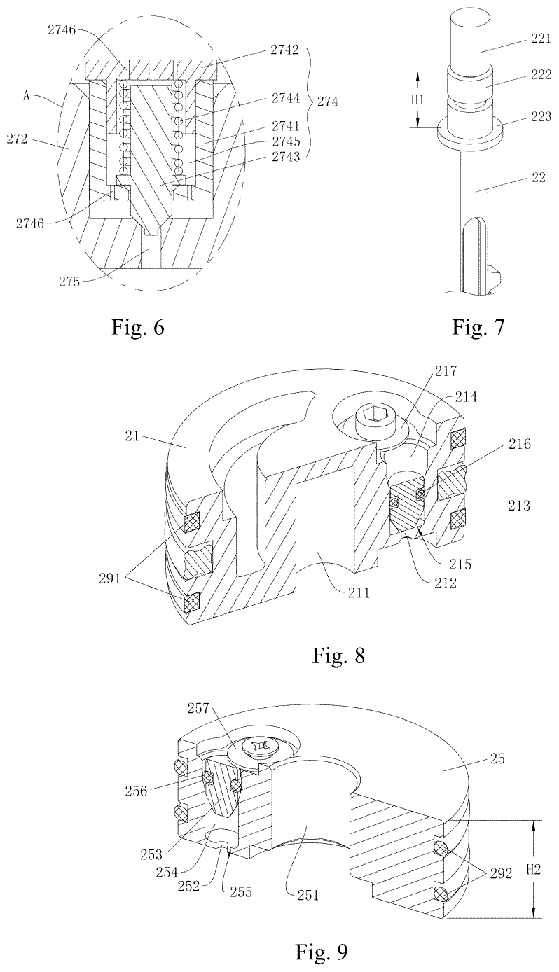

Referring to FIG. 6, in this embodiment, to ensure the nailing effect as well as operational safety of the tool, the cylinder unit 27 is further provided with a pressure relief valve 274 configured to adjust gas pressure in the driving gas chamber 24, where the pressure relief valve 274 opens when the gas pressure in the driving gas chamber 24 exceeds a predetermined pressure relief value P0. Specifically, the cylinder head 272 is provided with a pressure relief hole 275, the pressure relief valve 274 being disposed on the cylinder head 272 and configured to open and close the pressure relief hole 275. Furthermore, the pressure relief valve 274 comprises a valve housing 2741, a valve cover 2742, a valve stem 2743, and a spring 2744. The valve housing 2741 and the valve cover 2742 are detachably fixed together via thread fit or the like to form a cavity 2745. The valve stem 2743 is movably disposed in the cavity 2745, and one end of the valve stem 2743 facing the pressure relief hole 275 extends out of the cavity 2745. The end of the valve stem 2743 facing the pressure relief hole 275 is set to be conical or spherical so as to effectively open and close the pressure relief hole 275. The spring 2744 is sleeved on the valve stem 2743, one end of the spring 2744 being positionally fixed and the other end thereof abutting against the valve stem 2743. The spring 2744 in a compressed state biases the valve stem 2743 towards the direction of closing the pressure relief hole 275. The predetermined pressure relief value P0 of the driving gas chamber 24 depends on the biasing force exerted by the spring 2744 on the valve stem 2743. When the gas pressure in the driving gas chamber 24 is less than or equal to the predetermined pressure relief value P0, the valve stem 2743 closes the pressure relief hole 275 under the biasing action of the spring 2744. When the gas pressure in the driving gas chamber 24 exceeds the predetermined pressure relief value P0, the valve stem 2743 overcomes the biasing force of the spring 2744 under the action of the gas pressure in the driving gas chamber 24 to move in the direction of opening the pressure relief hole 275 to thereby open the pressure relief hole 275, allowing the gas in the driving gas chamber 24 to be discharged out of the driving gas chamber 24 via the pressure relief hole 275. To facilitate discharge of the gas in the driving gas chamber 24, the valve housing 2741 and the valve cover 2742 of the pressure relief valve 274 are both provided with an exhaust hole 2746, so that the gas discharged from the pressure relief hole 275 may be discharged out via the exhaust hole 2746 and the cavity 2745 in the pressure relief valve 274. The pressure relief valve 274 may be detachably mounted on the cylinder head 272 via thread fit or the like, or directly secured on the cylinder head 272. As an alternative solution of this embodiment, the pressure relief valve 274 can also be provided on the cylinder housing 271 or on the base 273 of the cylinder unit 27; of course, the pressure relief valve 274 can also adopt another existing valve structure that meets pressure relief requirements, and a specific structure of the pressure relief valve 274 is not limited herein.

In this embodiment, high-pressure gas may be fully pre-charged in the driving gas chamber 24 at the factory, where the gas pressure in the driving gas chamber 24 meets nailing requirements. Alternatively, high-pressure gas may be partially pre-charged in the driving gas chamber 24 at the factory, where the gas pressure does not meet the nailing requirements; upon nailing, the tool first undergoes a few free-running cycles so that the gas supplementation unit 2B supplements gas to the driving gas chamber 24, and then performs nailing when the gas pressure in the driving gas chamber 24 meets the requirements. Of course, it is also optional that no high-pressure gas is pre-charged in the driving gas chamber 24 at the factory; upon nailing, the tool first undergoes a few free-running cycles so that the gas supplementation unit 2B supplements gas to the driving gas chamber 24, and then performs nailing when the gas pressure meets the requirements. In a case that the driving gas chamber 24 is only partially pre-charged with high-pressure gas or not pre-charged with high-pressure gas at the factory, a gas pressure detection element configured to detect gas pressure in the driving gas chamber 24 may be provided on the cylinder unit 27. When a control module of the tool determines that the gas pressure in the driving gas chamber 24 meets the nailing requirements according to the gas pressure detection signal fed back by the detection element, it sends a prompt signal to indicate the user that the tool is ready for nailing. To enable gas pre charge into the driving gas chamber 24, a gas charging valve 276 may be provided on the cylinder unit 27; the gas charging valve 276 may be provided on an outer side of the cylinder housing 271, or a top side of the cylinder head 272, or a bottom side of the base 273.

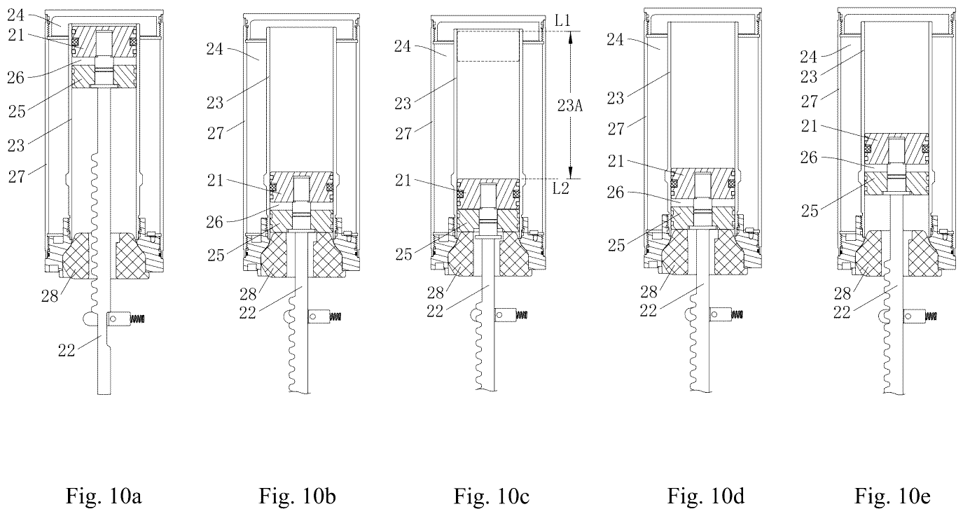

In this embodiment, the striking unit 2A and the gas supplementation unit 2B have an upper ready position and a lower end position. Referring to FIG. 10a, when the striking unit 2A and the gas supplementation unit 2B are in the ready position, the driving piston 21 is close to the upper end of the support cylinder 23, and the gas in the driving gas chamber 24 is in a high-pressure state. As a specific solution of this embodiment, when the striking unit 2A is in the ready position, an upper surface of the driving piston 21 may be slightly higher than, slightly lower than, or flush with an upper surface of the support cylinder 23.

To perform a nailing action, the striking unit 2A is released, the high-pressure gas in the driving gas chamber 24 drives the striking unit 2A to move downward, and the downward moving striking unit 2A drives the gas supplementation unit 2B to move downward together. Referring to FIG. 10b, when the gas supplementation piston 25 moves downward till contacting the damper block 28, it stops moving; when the gas supplementation piston 25 stops, the striking unit 2A continues moving downward; during continued movement of the striking unit 2A, the volume of the gas supplementation chamber 26 is quickly compressed, and correspondingly, the gas pressure in the gas supplementation chamber 26 increases sharply to exceed the gas pressure in the driving gas chamber 24; now, the gas supplementation check valve 213 opens the gas supplementation hole 212 in the driving piston 21 due to the sharp increase of the gas pressure in the gas supplementation chamber 26, allowing the gas in the gas supplementation chamber 26 to enter the driving gas chamber 24. When the gas pressure in the driving gas chamber 24 is substantially equal to the gas pressure in the gas supplementation chamber 26, the gas supplementation check valve 213 returns to the state of closing the gas supplementation hole 212, so that the driving gas chamber 24 and the gas supplementation chamber 26 are isolated from each other. Referring to FIG. 10c, when the driving piston 21 moves to substantially contact the gas supplementation piston 25, the striking unit 2A and the gas supplementation unit 2B move downward to the end position. During downward movement of the striker 22, a to-be-driven fastener 31 is driven into the workpiece 32; exemplarily, the striker 22 already engages the to-be-driven fastener 31 before the gas supplementation piston 25 stops, thereby ensuring movement speed of the striker 22 when engaging the fastener 31, which helps to ensure the nailing effect. In addition, volume variation of the gas supplementation chamber 26 may play a role of damping the striking unit 2A upon engaging the fastener 31, which may significantly reduce nailing vibration of the tool and improve user experience.

Referring to FIG. 10d, during upward movement of the striking unit 2A driven by the lifting assembly 40, the gas supplementation piston 25 remains stationary before the limiting portion 223 contacts the gas supplementation piston 25; the striking unit 2A first travels upward by a certain distance prior to the gas supplementation unit 2B; within this travel, the volume of the gas supplementation chamber 26 gradually increases, and correspondingly, the gas pressure in the gas supplementation chamber 26 decreases till being lower than the external atmospheric pressure; now, the gas inlet check valve 253 opens the gas inlet hole 252 in the gas supplementation piston 25, allowing the external air to enter the gas supplementation chamber 26 via the gas inlet hole 252; when the gas pressure in the gas supplementation chamber 26 substantially reaches the external atmospheric pressure, the gas inlet check valve 253 returns to the state of closing the gas inlet hole 252, so that the gas supplementation chamber 26 is isolated from the external air. Referring to FIG. 10e, when the striking unit 2A moves upward till the limiting portion 223 contacts the gas supplementation piston 25, the striking unit 2A continues to move upward, driving, via the limiting portion 223, the gas supplementation unit 2B to move upward synchronously.

The striking unit 2A and the gas supplementation unit 2B may stop moving when moving upward to the ready position, or stop when moving upward to a position lower than the ready position. When the stop position of the striking unit 2A and the gas supplementation unit 2B moving upward is lower than the ready position, in a next nailing cycle, the lifting assembly 40 first drives the striking unit 2A and the gas supplementation unit 2B to move upward to the ready position, and then nailing is performed. When the tool starts operation, the gas in the driving gas chamber 24 is relatively sufficient, so that the gas pressure in the gas supplementation chamber 26 may not exceed the gas pressure in the driving gas chamber 24 during downward movement of the striking unit 2A and the gas supplementation unit 2B; now, the gas supplementation chamber 26 does not supplement gas to the driving gas chamber 24, i.e., the gas supplementation unit 2B does not necessarily supplement gas to the driving gas chamber 24 in every nailing cycle. In addition, the ambient air is not necessarily inlet into the gas supplementation chamber 26 in every nailing cycle.

Referring to FIG. 10c, line L1 represents a height position of the upper surface of the driving piston 21 in the ready position, and line L2 represents a height position of the upper surface of the driving piston 21 in the end position; and the distance by which the driving piston 21 moves from the position indicated by line L1 to the position indicated by line L2 is the stroke of the driving piston 21 for performing a nailing action. V1 indicates a volume of the driving gas chamber 24 when the driving piston 21 is in the ready position, and V2 indicates a volume of the driving gas chamber 24 when the driving piston 21 is in the end position, where V2>V1, V2−V1 indicating a volume change of the driving gas chamber 24 caused by the stroke of the driving piston 21, and correspondingly, V2−V1 is the displacement volume 23A created by the stroke of the driving piston 21. In this embodiment, since the driving piston 21 is always located in the support cylinder 23, the part of inner cavity of the support cylinder 23 between lines L1 and L2 constitutes the displacement volume 23A of the driving piston 21.

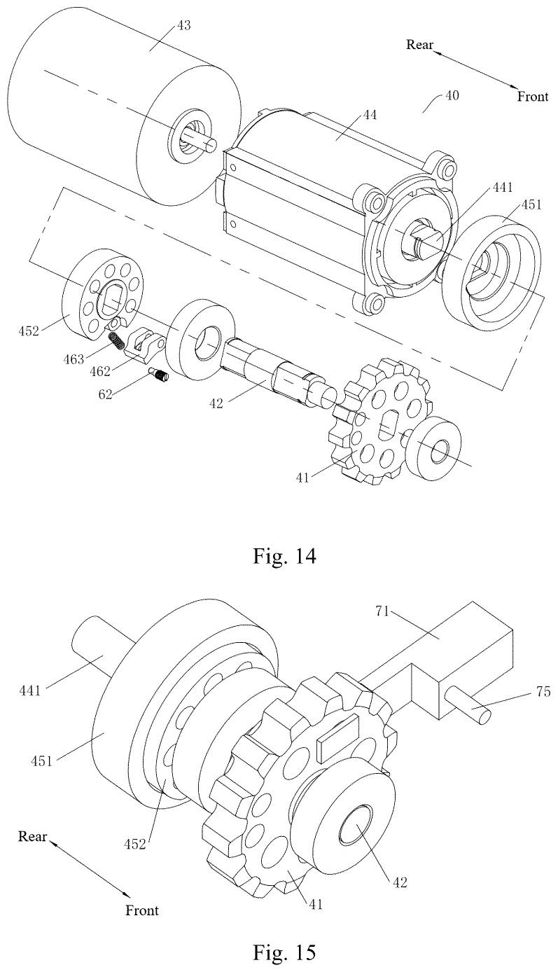

In this embodiment, a plurality of convex teeth 221 distributed at intervals along a vertical direction are provided at a side in the length direction of the striker 22; referring to FIGS. 14, 15, and 16, the lifting assembly 40 comprises an electric motor 43, a reduction gearbox 44, and a lifting gear 41. The lifting gear 41 may mesh with the convex teeth 221 on the striker 22 to drive the striker 22 to move upward toward the ready position, and the upward moving striker 22 drives the driving piston 21 and the gas supplementation piston 25 to move upward toward the ready position. Specifically, the electric motor 43 and the reduction gearbox 44 are arranged in the accommodation portion 52 of the enclosure 50; a support base 61 is secured under the base 273; the lifting gear 41 is sleeved on a transmission shaft 42; the transmission shaft 42 is rotatably mounted on the support base 61 via a bearing; and an axial direction of the lifting assembly 40 is substantially perpendicular to a length direction of the striker 22. A driving wheel 451 is sleeved on an output shaft 441 of the reduction gearbox 44, a driven wheel 452 is sleeved on a rear end of the transmission shaft 42, and an engageable/disengageable transmission structure is provided between the driving wheel 451 and the driven wheel 452. Referring to FIG. 13, when the transmission structure is in an engaged state, the electric motor 43 drives, via the reduction gearbox 44, the driving wheel 451 to rotate, the rotating driving wheel 451 drives, via the transmission structure, the transmission shaft 42 to rotate about its own central axis, the rotating transmission shaft 42 drives the lifting gear 41 to rotate synchronously in the direction indicated by +ω, the lifting gear 41 rotating in the +ω direction drives, via meshing with the convex teeth 221, the striker 22 to move upward toward the ready position, and the striker 22 moving upward drives the driving piston 21 and the gas supplementation piston 25 to also move toward the ready position.

Referring to FIGS. 17 and 18, a recessed cavity 4511 is formed on one side of the driving wheel 451 facing the driven wheel 452, the driven wheel 452 being disposed in the recessed cavity 4511. The transmission structure comprises a drive ratchet groove 461 formed on an inner wall of the recessed cavity 4511, a drive ratchet 462 arranged on the driven wheel 452 in a swingable manner, and a first spring 463 configured to bias the drive ratchet 462 toward the inner wall of the recessed cavity 4511. A rod shaft 62 configured to drive the drive ratchet 462 out of the drive ratchet groove 461 is provided on the support base 61. When the drive ratchet 462 is biased by the first spring 463 and fitted in the drive ratchet groove 461, the transmission structure is in an engaged state. The driving wheel 451 actuated to rotate by the electric motor 43 then drives, via the fit between the drive ratchet groove 461 and the drive ratchet 462, the transmission shaft 42 and the lifting gear 41 to rotate in the +ω direction, so that the lifting gear 41 may drive the striking unit 2A and the gas supplementation unit 2B to move upward to the ready position. When the drive ratchet 462 is pushed by the rod shaft 62 to overcome the bias of the first spring 463 to disengage from the drive ratchet groove 461, the transmission structure is in a disengaged state; to perform a nailing action, the downward-moving striker 22 drives the lifting gear 41 to rotate in the direction indicated by −ω, and the lifting gear 41 rotating in the −ω direction drives the transmission shaft 42 and the driven wheel 452 to rotate freely relative to the driving wheel 451; this prevents transmission of the reverse rotation to the reduction gearbox 44. To drive the striking unit 2A and the gas supplementation unit 2B to return to the ready position, the rotating driving wheel 451 may drive the drive ratchet 462 to be re-fitted into the drive ratchet groove 461.

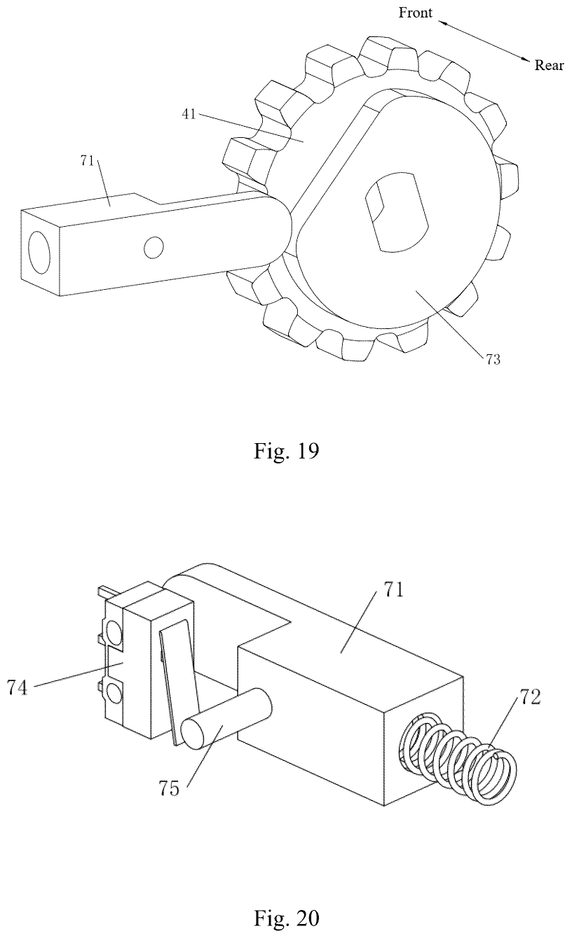

Referring to FIGS. 19 and 20, to lock the striking unit 2A and the gas supplementation unit 2B normally to the ready position, a slidable latch block 71 is provided on the support base 61, a sliding direction of the latch block 71 being substantially perpendicular to a movement direction of the striker 22. Referring to FIG. 13, specifically, the latch block 71 is disposed on the support base 61 in a left-right slidable manner, a slot 222 fitted with the latch block 71 is formed on the lower end of the striker 22, and a second spring 72 biasing the latch block 71 toward the slot 222 is further provided on the support base 61. A cam 73 configured to unlock the latch block 71 is sleeved on the transmission shaft 42 the cam 73 may be unitarily formed with the lifting gear 41, or may be separately formed relative to the lifting gear 41. Normally, the latch block 71 is partially fitted in the slot 222 to keep the striking unit 2A and the gas supplementation unit 2B in the ready position. To perform a nailing action, the electric motor 43 first actuates the lifting gear 41, the transmission shaft 42, and the cam 73 to rotate in the +ω direction. The cam 73 rotating in the +ω direction drives the latch block 71 to overcome the bias of the second spring 72 to slide away from the slot 222, so that the latch block 71 releases the striker 22. Almost simultaneously, the transmission structure switches from the engaged state to the disengaged state; the released striker 22 is driven by the driving piston 21 to move rapidly downward, and the downward-moving striker 22 drives the lifting gear 41, the transmission shaft 42, and the driven wheel 452 to rotate reversely relative to the driving wheel 451. When the lifting gear 41 drives the striker 22 to move upward to the ready position, the latch block 71 is aligned with the slot 222, and the latch block 71 is biased by the second spring 72 to slide toward the slot 222 so as to be fitted in the slot 222, thereby locking the striking unit 2A and the gas supplementation unit 2B to the ready position.

To enable the electric motor 43 to stop promptly, a limit switch 74 is fixedly provided on the support base 61, and a pin rod 75 configured to trigger the limit switch 74 is provided on the latch block 71. A control module is provided in the enclosure 50, the limit switch 74 communicates with the control module, and the electric motor 43 is controlled by the control module. The pin rod 75 releases the limit switch 74 when the latch block 71 migrates out of the slot 222, and triggers the limit switch 74 when the latch block 71 is re-fitted in the slot 222. The control module may command the electric motor 43 to stop in response to a trigger signal from the limit switch 74.

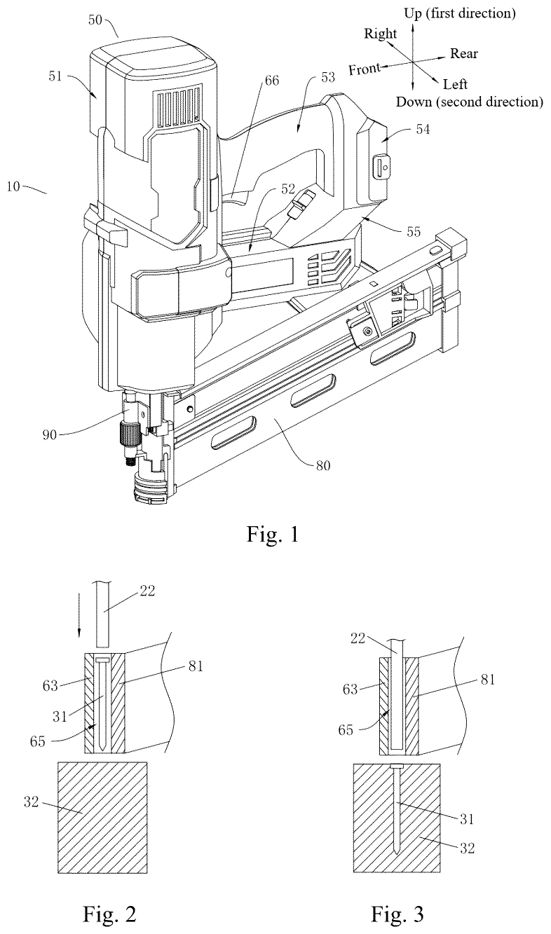

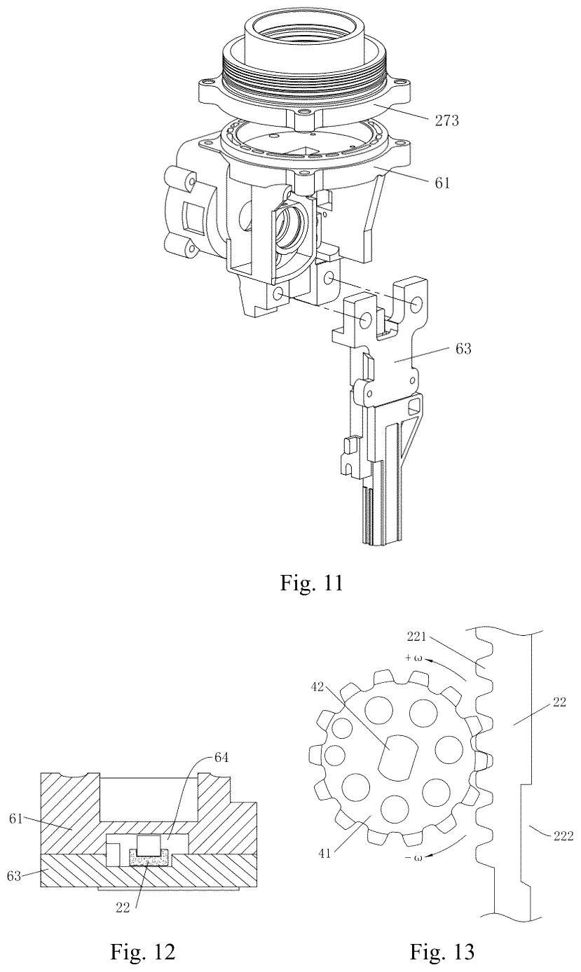

Referring to FIGS. 11 and 12, in this embodiment, a guide base 63 is secured on a front side of the support base 61, and a limit passage 64 in which the striker 22 moves up an down is formed between the guide base 63 and the support base 61. The fastener driving tool 10 further comprises a nail feeder 80 removably attached to the guide base 63, and a guide cover 81 is provided at a front end of the nail feeder 80. Referring to FIGS. 2 and 3, when the nail feeder 80 is attached to the guide base 63, the guide base 63 is fitted with the guide cover 81 to form a guide passage 65 open at both upper and lower ends. The nail feeder 80 outputs a to-be-driven fastener 31 into the guide passage 65, and the downward-moving striker 22 enters the guide passage 65 to drive the to-be-driven fastener 31 downward into the workpiece 32. The striker 22 moving upward to the ready position migrates upward out of the guide passage 65, so that the nail feeder 80 may smoothly output a next to-be-driven fastener 31 into the guide passage 65. In this embodiment, the fastener 31 driven into the workpiece 32 may be a straight nail, a U-shaped nail, or another reasonable shape.

Referring to FIG. 1, a main switch is provided inside a front end of the grip portion 53 and communicates with the control module, and a trigger 66 configured to trigger the main switch is provided on a bottom side of the front end of the grip portion 53. The enclosure 50 is further provided with a reinforcement portion 55 disposed between the accommodation portion 52 and the receiving portion 54, and the control module may be disposed in the reinforcement portion 55. The nail feeder 80 is removably attached to the enclosure 50; to enhance stability of attachment of the nail feeder 80 to the enclosure 50, a quick-release connection structure may be provided between the nail feeder 80 and the reinforcement portion 55.

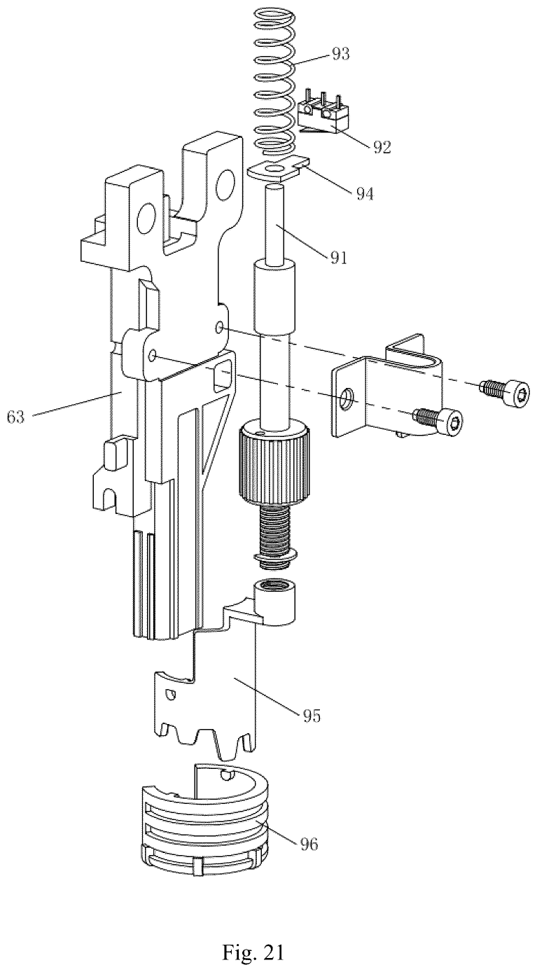

Referring to FIG. 21, the fastener driving tool 10 is further provided with a safety assembly 90. Specifically, the safety assembly 90 comprises a driver rod 91, a safety switch 92, a third spring 93, a locating rack 95, and an elastic member 96, where the driver rod 91 is disposed at a front side of the guide base 63 in an up-down movable manner with a limited travel, an upper end of the driver rod 91 extends into the body portion 51 and is provided with a contact plate 94 configured to trigger the safety switch 92, the safety switch 92 may be secured on the support base 61 or on the guide base 63 and communicates with the control module, the third spring 93 biases the driver rod 91 downward so that the contact plate 94 normally releases the safety switch 92, the locating rack 95 is secured to a lower end of the driver rod 91, and the elastic member 96 is sleeved outside the locating rack 95 or disposed at a bottom portion of the locating rack 95. To perform a nailing action, the locating rack 95 is pressed against the workpiece 32 and drives the driver rod 91 to move upward against the bias of the third spring 93 so that the contact plate 94 triggers the safety switch 92. Only when the safety switch 92 and the main switch are both triggered, can the tool initiate the nailing process; as to the sequence of triggering the safety switch 92 and the main switch, the present application has no limitation. To facilitate adjusting a nailing depth, the locating rack 95 is exemplarily connected to a lower end of the driver rod 91 via threaded fit. As an alternative solution of this embodiment, the driver rod 91 may also be provided at a left side or a right side of the guide base 63.

After the nailing process is initiated, the rotating cam 73 drives the latch block 71 to migrate out of the slot 222, so that the latch block 71 releases the striker 22; the high-pressure in the driving gas chamber 24 drives the striking unit 2A and the gas supplementation unit 2B to move downward, and the downward-moving striker 22 extends into the guide passage 65 to drive the to-be-driven fastener 31 downward into the workpiece 32 the gas in the gas supplementation chamber 26 may enter the driving gas chamber 24; the lifting gear 41 rotates in the direction indicated by −ω during downward movement of the striking unit 2A.

After the striking unit 2A and the gas supplementation unit 2B move to the end position, the lifting gear 41 is actuated by the electric motor 43 to rotate in the direction indicated by +ω, the rotating lifting gear 41 drives the striking unit 2A to move upward prior to the gas supplementation unit 2B so that the ambient air may enter the gas supplementation chamber 26; then the upward-moving striking unit 2A drives the gas supplementation unit 2B to move upward synchronously. When the striking unit 2A and the gas supplementation unit 2B move to the ready position, the electric motor 43 stops.

As an alternative solution of this embodiment, to control the travel of the striker 22, a magnetic induction switch may be used as an alternative to the limit switch 74. Specifically, a magnet is provided on the striker 22, and two magnetic induction elements vertically distributed are provided on the support base 61 and/or the guide base 63, the magnetic induction elements communicating with the control module, so that the control module determines a position of the striker 22 based on a triggering status of the magnetic induction elements. The magnetic induction elements may be Hall elements, reed switches, or the like. When the striker 22 moves to the position where the magnet triggers one of the magnetic induction elements, it indicates that the striker 22 has moved to the ready position. When the striker 22 moves to the position where the magnet triggers the other magnetic induction element, it indicates that the striker 22 has moved to the end position. Of course, the magnet may also be disposed on the lifting gear 41.

As an alternative solution of this embodiment, the transmission structure of the lifting assembly 40 may also adopt an axially engageable/disengageable structure. In this case, the driven wheel 452 or the driving wheel 451 may slide axially. To perform a nailing action, the driving wheel 451 and the driven wheel 452 are in the disengaged state, so that the driven wheel 452 may rotate freely relative to the driving wheel 451; upon completion of the nailing action, the driving wheel 451 and the driven wheel 452 return to the engaged state under the bias of the spring.

As an alternative solution of this embodiment, a connecting rod may also be provided between the striker 22 and the driving piston 21, an upper end of the striker 22 being connected to the connecting rod, an upper end of the connecting rod being connected to the driving piston 21, the convex teeth 221 meshing with the lifting gear 41 being disposed on the connecting rod. The lifting gear 41 rotating in the +ω direction drives, via the connecting rod, the striking unit 2A and the gas supplementation unit 2B to move upward toward the ready position.

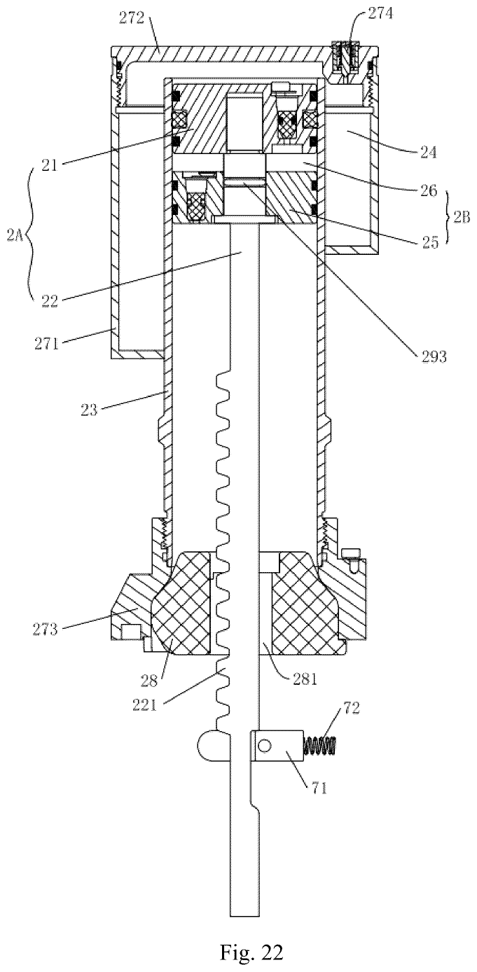

Referring to FIG. 22, as an alternative solution of this embodiment, the cylinder housing 271 may be configured with a non-columnar irregular structure. In this case, the cylinder housing 271 is disposed outside a partial section of the support cylinder 23, and the cylinder housing 271 is not secured to the base 273. The cylinder housing 271 and the support cylinder 23 may be unitarily formed, or may be separately formed and then secured together. Of course, the cylinder housing 271 can also be configured as another reasonable structure.

As an alternative solution of this embodiment, the lifting gear 41 may be provided with a toothless portion, i.e., the teeth on the lifting gear 41 are not continuously arranged along the circumferential direction. To perform a nailing action, the toothless portion of the lifting gear 41 faces the striker 22, allowing avoiding the convex teeth 221 on the striker 22, so that the striker 22 may move downward smoothly, preventing the lifting gear 41 from interfering with the nailing action of the striker 22. Upon completion of the nailing, the lifting gear 41 rotating in the +ω direction re-meshes with the convex teeth 221 to drive the striking unit 24 and the gas supplementation unit 2B upward toward the ready position. In this solution, the lifting gear 41 with the toothless portion may be directly sleeved on the output shaft 441 of the reduction gearbox 44, eliminating a need for the transmission shaft 42; of course, the lifting gear 41 may still be sleeved on the transmission shaft 42, in which case a coupling is arranged between the transmission shaft 42 and the output shaft 441.

As an alternative solution of this embodiment, the lifting assembly 40 may also adopt the drive assembly 400 described in the utility patent CN221539660U. In this case, no convex teeth 221 are provided on the striker 22 of this embodiment; the rack used as a movable part 420 in CN221539660U is arranged to be movable up and down relative to the striker 22 in this embodiment.

As an alternative solution of this embodiment, the latch block 71 can also be pivotally disposed.

As an alternative solution of this embodiment, the cam 73 may also be canceled. In this case, the actions of the latch block 71 to release and lock the striker 22 are both actuated by an electromagnetic solenoid controlled by the control module.

As an alternative solution of this embodiment, the striking unit 2A and the gas supplementation unit 2B may also be normally disposed in the end position. To initiate a nailing cycle, the lifting gear 41 first actuates the striking unit 2A and the gas supplementation unit 2B to move upward to the ready position. Then, the transmission structure switches to the disengaged state, and the high-pressure in the driving gas chamber 24 drives the striking unit 2A and the gas supplementation unit 2B to move downward toward the end position. In this case, the latch block 71, the second spring 72, the cam 73, the limit switch 74, and the pin rod 75 may be cancelled.

As a further solution of this embodiment, the tool is provided with a single-shot mode and a continuous-shot mode. An operable mode selector is provided on the enclosure 50, and the user can switch for a nailing mode of the tool through the mode selector. The mode selector may be configured as a bidirectionally sliding push block, a pivotal button, a rotary knob, a key, a touch screen, or another reasonable manner.

In addition to the exemplary embodiments described supra, the present disclosure has other embodiments. Those skilled in the art may make various changes and modifications according to the present disclosure; all such changes and modifications without departing from the spirit of the present application shall fall within the scope defined in the appended claims.

I/We claim:

1. A fastener driving tool, comprising:
a support cylinder, two axial ends of which are oriented in a first direction and a second direction, respectively;
a striking unit having a driving piston and a striker, the driving piston being disposed inside the support cylinder in an axially movable manner, the support cylinder having a displacement volume created by a stroke of the driving piston, one end of the striker facing the first direction being connected to the driving piston, and one end of the striker facing the second direction being configurable to engage a to-be-driven fastener;
a driving gas chamber in fluid communication with the displacement volume, high-pressure gas in the driving gas chamber being capable of driving the striking unit to move in the second direction; and
a lifting assembly configured to drive the striking unit to move in the first direction;
wherein the fastener driving tool further comprises a gas supplementation unit disposed inside the support cylinder, the gas supplementation unit comprising a gas supplementation piston and a gas supplementation chamber, the gas supplementation piston being connected to the striker and disposed in the second direction of the driving piston, the gas supplementation chamber being disposed between the driving piston and the gas supplementation piston, the gas supplementation piston being movable within a predetermined range relative to the striker to induce variation of a volume of the gas supplementation chamber;
as the striking unit moves in the second direction, the volume of the gas supplementation chamber is reduced, allowing gas in the gas supplementation chamber to enter the driving gas chamber; and
as the striking unit moves in the first direction, the volume of the gas supplementation chamber expands, allowing ambient air to enter the gas supplementation chamber.

2. The fastener driving tool according to claim 1, wherein the driving piston is provided thereon with a gas supplementation hole and a gas supplementation check valve configured to open/close the gas supplementation hole, the gas supplementation check valve being adapted to open the gas supplementation hole when gas pressure in the gas supplementation chamber is higher than gas pressure in the driving gas chamber.

3. The fastener driving tool according to claim 1, wherein the gas supplementation piston is provided thereon with a gas inlet hole and a gas inlet check valve configured to open/close the gas inlet hole, the gas inlet check valve being adapted to open the gas inlet hole when atmospheric pressure of ambient air is higher than gas pressure in the gas supplementation chamber.

4. The fastener driving tool according to claim 1, wherein the fastener driving tool further comprises a pressure relief valve configured to adjust gas pressure in the driving gas chamber, the pressure relief valve being adapted to open when the gas pressure in the driving gas chamber exceeds a predetermined pressure relief value.

5. The fastener driving tool according to claim 1, wherein a damper block that is elastic is provided at the end of the support cylinder facing the second direction, and the striking unit continues moving in the second direction after the gas supplementation piston engages the damper block, thereby compressing the volume of the gas supplementation chamber.

6. The fastener driving tool according to claim 1, wherein the striking unit moves in the first direction prior to the gas supplementation piston, and the volume of the gas supplementation chamber expands as the striking unit moves in the first direction prior to the gas supplementation piston.

7. The fastener driving tool according to claim 1, wherein the gas supplementation piston is sleeved on the striker, the striker being provided with a limiting portion configured to limit the gas supplementation piston, the gas supplementation piston being movable between the driving piston and the limiting portion relative to the striker.

8. The fastener driving tool according to claim 7, wherein the striker moving in the first direction may drive, via the limiting portion, the gas supplementation piston to move synchronously; and/or, the striker is provided with a support portion between the driving piston and the limiting portion, the support portion having an outer diameter smaller than that of the limiting portion, the gas supplementation piston being disposed at the support portion, a sealing ring being provided between the support portion and the gas supplementation piston to maintain a circumferential sealing fit therebetween.

9. The fastener driving tool according to claim 1, wherein the driving piston and the support cylinder maintain a circumferential sealing fit; and/or, the gas supplementation piston and the support cylinder maintain a circumferential sealing fit.

10. The fastener driving tool according to claim 1, wherein the driving gas chamber is arranged to surround at least part of the support cylinder, and the driving gas chamber is at least partially disposed above the support cylinder.
